(19) United States
(12) Patent Application Publication
(10) Pub. No.: US 2026/0162103 A1
(43) Pub. Date: Jun. 11, 2026

(54) SYSTEMS AND METHODS FOR IMPLEMENTING MULTI-INSTITUTION DIGITAL WALLET BROWSER EXTENSION

(71) Applicant: Capital One Services, LLC, McLean, VA (US)

(72) Inventors: Kaiss Fayed, McLean, VA (US); Matthew Kloster, Falls Church, VA (US); Jeffrey Rule, Chevy Chase, MD (US)

(73) Assignee: Capital One Services, LLC, McLean, VA (US)

(21) Appl. No.: 18/971,061

(22) Filed: Dec. 6, 2024

(51) Int. Cl. G06Q 20/36; G06Q 20/12; G06Q 20/22; G06Q 20/32; G06Q 20/38

(52) U.S. Cl. CPC G06Q 20/3674; G06Q 20/385; G06Q 20/12; G06Q 20/227; G06Q 20/326; G06Q 2220/00

(57) ABSTRACT

Systems and methods for a multi-institution digital wallet browser extension are provided herein. Methods include providing a browser extension on a web browser of a computing device, the browser extension enabling operation of a digital wallet, wherein the web browser is configured to access a merchant website including a checkout page having at least one entry field thereon, automatically prompting a user to select a payment instrument from a list associated with the digital wallet, receiving a selection of the payment instrument, prompting the user to authenticate an identity of the user, and receiving authentication data regarding the identity of the user. Methods further include sending the authentication data to an authentication server to verify the authentication data, receiving an indication from the authentication server that the authentication data is verified, and populating the at least one entry field with personal data associated with the user.

### BACKGROUND

Digital wallets have become ubiquitous in completing transactions over the Internet. Digital wallets are used to store user payment data so that payment data can be easily added at checkout when purchasing goods or paying for utilities and services. However, there is a need for advanced features regarding digital wallets and their use in online transactions. For example, there is a need for additional security beyond what is already provided on current systems.

In addition, merchants seeking to offer a digital wallet often must add the digital wallet as a standalone integration to the platform used for their checkout services. This may require merchants to develop software supporting wallet functionality into their platform and services.

These and other deficiencies exist. As such, there is need for an improved system and process for the implementation and use of digital wallets that promotes user convenience, improves security, reduces the burden of implementation, and streamlines online transactions.

Aspects of the present application include systems and methods implementing multi-institution digital wallet browser extensions.

### SUMMARY

In one aspect, a method for multi-institution digital wallet browser extension is provided. In some embodiments, the method includes providing a browser extension on a web browser of a mobile device, the browser extension enabling operation of a digital wallet on the mobile device, where the web browser is configured to access a merchant website including a checkout page having at least one entry field thereon. The method further includes automatically prompting, by the browser extension, a user to select a payment instrument from a list of one or more payment instruments associated with the digital wallet. The method further includes receiving, by the browser extension, a selection of the payment instrument. The method further includes launching a computer application corresponding to the payment instrument selected. The method further includes receiving authentication data of the user at the computer application. The method further includes sending the authentication data to an authentication server for validation. The method further includes, in response to the authentication data of the user being validated, the browser extension receiving, from a centralized digital wallet server, an authorization token, wherein the mobile device is redirected from the computer application back to the merchant website on the web browser. The method further includes sending, by the browser extension, a request to the centralized digital wallet server for personal data associated with the user, the request including the authorization token. The method further includes receiving, by the browser extension from the centralized digital wallet server, the personal data associated with the user. The method further includes populating, by the browser extension, at least one entry field on the checkout page with the personal data.

In another aspect, a computing device for multi-institution digital wallet browser extension is provided. The computing device includes a memory storing executable instructions thereon. The computing device also includes a processing circuit to execute the instructions, which when executed, cause the processing circuit to perform various operations. In some embodiments, the processing circuit is caused to access a website via a web browser, the website including a webpage having at least one entry field to be filled with data. In some embodiments, the processing circuit is caused to enable operation of a digital wallet by activating a browser extension on the web browser, the browser extension being associated with a bank with which a user of the computing device has a banking account. In some embodiments, the processing circuit is caused to display a prompt for the user to select a payment method from a list of one or more payment methods saved within the digital wallet. In some embodiments, the processing circuit is caused to receive a selection from the user for the payment method. In some embodiments, the processing circuit is caused to execute, based on the selection, a mobile banking application, and display within the mobile banking application, a prompt for the user to provide login credentials for the banking application. In some embodiments, the processing circuit is caused to receive the login credentials from the user. In some embodiments, the processing circuit is caused to, in response to the login credentials being validated, receive an authentication token from a digital wallet server, the authentication token being received by the browser extension. In some embodiments, the processing circuit is caused to send, from the browser extension, a request to a digital wallet server for personal data associated with the user, the request including the authentication token. In some embodiments, the processing circuit is caused to receive, at the browser extension, the personal data from the digital wallet server, and use the browser extension to automatically fill the at least one entry field with the personal data associated with the user.

In yet another aspect, a non-transitory computer-readable storage medium for multi-institution digital wallet browser extension is provided. The non-transitory computer-readable storage medium includes executable instructions stored thereon, which when executed by a processing circuit of a computing device, cause the computing device to perform various operations. For example, in some embodiments, the processing circuit is caused to execute a browser extension on a web browser of the computing device, the browser extension enabling operation of a digital wallet on the computing device, where the web browser is configured to access a merchant website including a checkout section having at least one personal information field to be filled in. In some embodiments, the processing circuit is caused to automatically prompt, by the browser extension, a user to select a payment method from a list of one or more payment methods associated with the digital wallet. In some embodiments, the processing circuit is caused to receive, by the browser extension, a selection of the payment method. In some embodiments, the processing circuit is caused to launch a computer application corresponding to the payment instrument selected. In some embodiments, the processing circuit is caused to receive authentication data of the user at the computer application. In some embodiments, the processing circuit is caused to send the authentication data to an authentication server for validation. In some embodiments, the processing circuit is caused to receive, from a digital wallet server, an authorization token, where the mobile device is redirected from the computer application back to the merchant website on the web browser. In some embodiments, the processing circuit is caused to send, by the browser extension, a request to the digital wallet server for personal data associated with the user, the request including the authorization token. In some embodiments, the processing circuit is caused to receive, by the browser extension from the digital wallet server, the personal data associated with the user. In some embodiments, the processing circuit is caused to fill, by the browser extension, the at least one personal information field on the checkout section with the personal data.

Non-transitory computer program products (e.g., physically embodied computer program products) are also described that store instructions, which, when executed by one or more data processors (e.g., processor circuit) of one or more computing systems, cause at least one data processor to perform one or more of the operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows.

FIG. 1 is a network diagram of an example system in accordance with embodiments discussed herein.

FIG. 2 is a block diagram of an example mobile device in accordance with embodiments discussed herein.

FIG. 3 is a block diagram of an example web server in accordance with embodiments discussed herein.

FIG. 4 is a block diagram of an example centralized digital wallet server in accordance with embodiments discussed herein.

FIG. 5 illustrates an example sequence flow in accordance with embodiments discussed herein.

FIG. 6 illustrates a contactless card in accordance with embodiments discussed herein.

FIG. 7 illustrates a transaction card component in accordance with embodiments discussed herein.

FIG. 8 is a flow chart illustrating various operations performed in a method in accordance with embodiments discussed herein.

FIG. 9 illustrates a sequence flow in accordance with embodiments discussed herein.

FIG. 10 illustrates an example of a system configured to operate in accordance with embodiments discussed herein.

FIG. 11 illustrates another sequence flow in accordance with embodiments discussed herein.

FIG. 12A illustrates another sequence flow in accordance with embodiments discussed herein.

FIG. 12B illustrates another sequence flow in accordance with embodiments discussed herein.

FIG. 12C illustrates another sequence flow in accordance with embodiments discussed herein.

FIG. 13 illustrates an example message format in accordance with embodiments discussed herein.

FIG. 14 is a block diagram of example computer architecture in accordance with embodiments discussed herein.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Described herein is a system for a multi-institution digital wallet browser extension. The browser extension is used to implement a digital wallet for executing online transactions. In some embodiments, the browser extension can be installed on a user's browser simultaneously with a mobile banking application for the bank. That is, when a user downloads the mobile banking application, or other type of banking software application, the browser extension can be simultaneously downloaded onto the browser of the computing device on which the banking application is downloaded. The browser extension allows the multi-institution digital wallet to operate on the computing device, such as a mobile device, or other computing device. In the banking application, users can enroll to use the multi-institution digital wallet extension and this will cause a first hypertext transfer protocol (HTTP) cookie to be shared with the browser of the user's mobile device and the browser extension. This HTTP cookie creates a device binding or trust between the user's mobile device (or other device operating the application and browser) and a centralized digital wallet server. Users that download a desktop version of the browser extension may complete a similar procedure to enroll after logging in with their bank credentials in the desktop browser and create a device HTTP cookie for the desktop as well. The HTTP cookie may also be referred to herein as a “temporary browser data file” or a “browser data file.” The HTTP cookie (e.g., “temporary browser data file” or “browser data file”) can be generated by the bank server described below (e.g., the server that works as the backend to the mobile bank application described herein) and shared with the browser extension, or the HTTP cookie (e.g., “temporary browser data file” or “browser data file”) can be generated by the centralized digital wallet server described below.

One way in which the browser extension and the digital wallet are used is in Internet or online transactions. In some embodiments, the user may log into a website or go through the purchasing process as a guest. When the user navigates, via the web browser, to a merchant website and then selects an email field, phone number field, shipping field or some other field on the website to indicate a desire to purchase goods, the browser extension is configured to inject Javascript into the website that invites the user to use the digital wallet browser extension, e.g., as a pop-up in the browser or in a dialog box. The user can then accept or decline to use the digital wallet browser extension. If the user accepts and indicates on their device that they accept (e.g., selects a digital button to use the digital wallet browser extension), the banking application that was installed on the device is launched. Step up occurs after the banking application is launched and an authentication token (e.g., oAuth token) is generated by the bank application operating on the bank server.

Step up refers to identity verification of the user, if deemed necessary by the banking application. Step up may include the user logging into the banking application with their username and password. Step up may further include identity verification by facial recognition verification (e.g., using Face ID on a mobile device). Step up may further include the banking server sending a one-time-password (OTP) via short message service (SMS) text message to the user's phone or mobile device. The OTP is provided to the user's device via text message and the OTP is then requested by the banking application while the user is logging into the application. Step up may also require the user to tap their contactless card to the mobile device to send encrypted data to the mobile device, wherein the encrypted data is then sent to an authentication server to be verified, and this verifies the user's identity. Step up may also include scanning, by the user's mobile device, a government issued identification card. Based on risk signals, the banking application can include one or more of the above step up methods to challenge the user's identity.

The authentication token is shared with the browser extension on the user device via a digital link (e.g., universal resource locator (URL)). The authentication token is used by the browser extension to make application programming interface (API) requests on behalf of a user. The authentication token represents the authorization of a specific application (e.g., the browser extension) to access specific parts of a user's data (e.g., the user's personal data and any payment information from the centralized digital wallet server). Multi-factor authentication can occur to validate the user's identity before any payment information is entered into the website by the browser extension.

While the banking application is still executing, the user is prompted to enter their login credentials (e.g., this can be another factor for multi-factor authentication), the user is then redirected back to the website where the transaction is being performed and the authentication token is used by the browser extension along with the HTTP cookie described above, to pull personally identifying information (PII), a virtual card number (VCN), and/or a bound virtual card number (BVCN) from the centralized digital wallet server (e.g., PII, VCN, and/or a BVCN associated with the user). The browser extension may function by creating a merchant-bound or website-bound token in the form of a BVCN that auto-fills in guest checkout for the user as they check out from individual merchants via the browser.

As part of the multi-factor authentication, the user can provide encrypted data from a contactless card associated with their account and associated with the centralized digital wallet server. The contactless card can be used as a form of authentication, by the contactless card sending encrypted data, as described herein, to be sent to an authentication server to validate the encrypted data and thereby the user's identity. In some instances, contactless card functions discussed herein may be utilized in a multi-issuer computing environment. These functions may include tap-to functions where a user may tap their contactless card on a device, such as a mobile device, to perform a function. For example, verifying their identity discussed above.

The techniques described herein provide an improvement to computer related technology, namely, digital wallets, browser extensions, and security in online commercial interactions. The present disclose provides an improvement to digital wallets by adding additional layers of security and interoperability between financial institutions. The disclosed techniques improve browser extensions by adding additional features such as the disclosed payment features and security features, including the authentication token described herein. The techniques described herein also provide improved security for online commercial interactions by implementing a digital wallet browser extension with bound virtual card numbers that can only operate with individual merchants and cannot be used elsewhere.

The systems discussed here may enable users to perform these functions in a multi-issuer environment. Further, the systems discussed herein enable card issuers or payment providers, such as banks, to issue contactless cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, desirable, or even possible in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

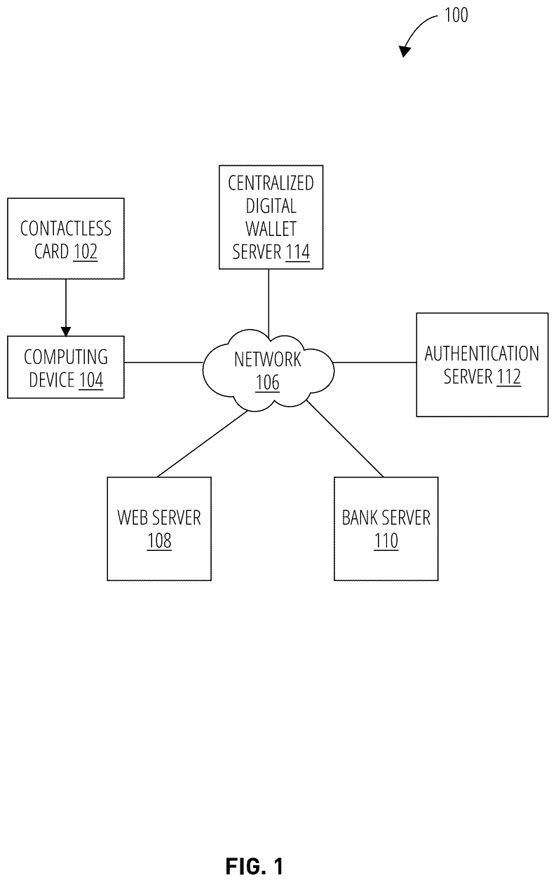

FIG. 1 illustrates system 100 for providing a multi-institution digital wallet browser extension according to an example embodiment. As further discussed below, system 100 may include contactless card 102, computing device 104, network 106, a web server 108, a bank server 110, and authentication server 112, and a centralized digital wallet server 114. Although FIG. 1 illustrates single instances of the components, system 100 may include any number of components.

System 100 may include one or more contactless cards 102, which are further explained below. In some embodiments, contactless card 102 may be in wireless communication, utilizing NFC in an example, with computing device 104. As described below, the contactless card 102 may provide one factor of authentication to authenticate an identity of the user of the computing device 104 to approve a usage of the digital wallet browser extension.

System 100 may include computing device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Computing device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The computing device 104 can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The computing device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, computing device 104 of system 100 may execute one or more applications, such as software applications, that enable, for example, network communications with one or more components of system 100 and transmit and/or receive data.

The computing device 104 may be in communication with one or more servers such as a web server 108, a, bank server 110, an authentication server 112, and/or a centralized digital wallet server 114 via one or more network(s) 106, and may operate as a respective front-end to back-end pair with any of those servers. The computing device 104 may transmit, for example from a mobile device application (e.g., a browser) executing on computing device 104, one or more requests to web server 108. The one or more requests may be associated with retrieving data from web server 108. The web server 108 may receive the one or more requests from computing device 104. Based on the one or more requests from computing device 104, web server 108 may be configured to retrieve the requested data from one or more datastores (not shown). Based on receipt of the requested data from the one or more datastores, web server 108 may be configured to transmit the received data to computing device 104, the received data being responsive to one or more requests. This may include loading a webpage from the web server 108, for example, a webpage for performing an Internet transaction.

System 100 may include one or more networks 106. In some examples, network 106 may be one or more of a wireless network, a wired network or any combination of wireless network and wired network, and may be configured to connect computing device 104 to web server 108, bank server 110, authentication server 112, and centralized digital wallet server 114. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more servers, such as web server 108, bank server 110, authentication server 112, and centralized digital wallet server 114. In some examples, each of the servers may include one or more processors, which are coupled to memory. The web server 108 may be configured to host a website for the computing device 104 to access and make one or more purchases thereon. In some embodiments, the web server 108 may include computer code and instructions thereon for hosting the website and for communicating website data to the computing device 104 so the computing device 104 can download and access the website. Functionality of the web server 108 is discussed in greater detail below.

The bank server 110 may be a server controlled by a financial institution. The bank server 110 may host a banking application which the computing device 104 can download, and the computing device 104 and the bank server 110 operates as a backend to frontend pair for the banking application. Additional functionality of the banking server is provided below.

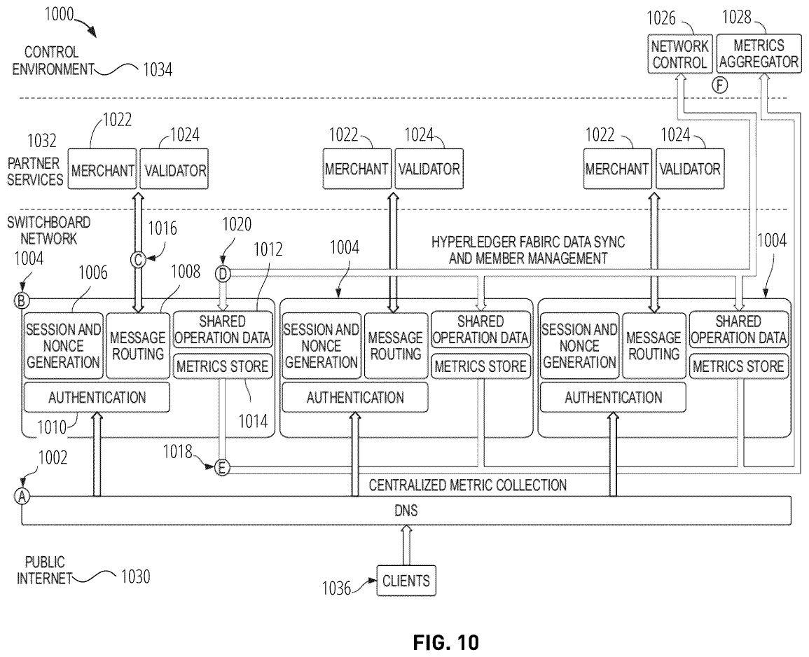

The authentication server 112 is a server that can be, for example, hosted in the system 1000 shown below in FIG. 10. For example, the authentication server 112 can be a node 1004 of the switching system 1000 described in FIG. 10. The authentication server 112 can operate to provide authentication services for the user. For example, in some embodiments, the authentication server 112 can receive and decrypt encrypted data from the contactless card 102 to act as a validation system of the identity of the user of the computing device 104 and therefore provide a factor of authentication for the digital wallet browser extension system described herein.

The centralized digital wallet server 114 is a central server that can, for example, host personal identifying information (PII) and payment information (e.g., virtual card numbers (VCNs) and/or bound VCNs (BVCNs) for corresponding user accounts associated with the centralized digital wallet server 114. The centralized digital wallet server 114 can communicate the PII and VCNs or BVCNs to a browser extension downloaded onto the browser of the computing device 104. The centralized digital wallet server 114 can perform various other functions described in more detail below.

The VCNs and BVCNs are generated by the bank server 110 or the centralized digital wallet server 114. A VCN is a unique card number associated with the actual account number of a user's credit card. The VCN is used in place of the actual account number of the user's credit card so that the user's actual account number is not provided to the public (e.g., in a transaction where the VCN is used). The bank server 110 or the centralized digital wallet server 114 generates the VCN for the contactless card and then associates or connects the VCN to the user's account. As such, when the VCN is received in a transaction request, the bank server 110 or centralized digital wallet server 114 can correlate the VCN to the user's actual account number and charge the account appropriately. A bound VCN is a VCN that is bound to a particular context. For example, the BVCN can be bound to a particular merchant, particular date, time, geographic location, etc. For example, if the user has a BVCN for Merchant A, the BVCN will only allow the user to perform transactions using the BVCN at Merchant A. If the user tries to use the BVCN bound to Merchant A at Merchant B, the transaction will be denied.

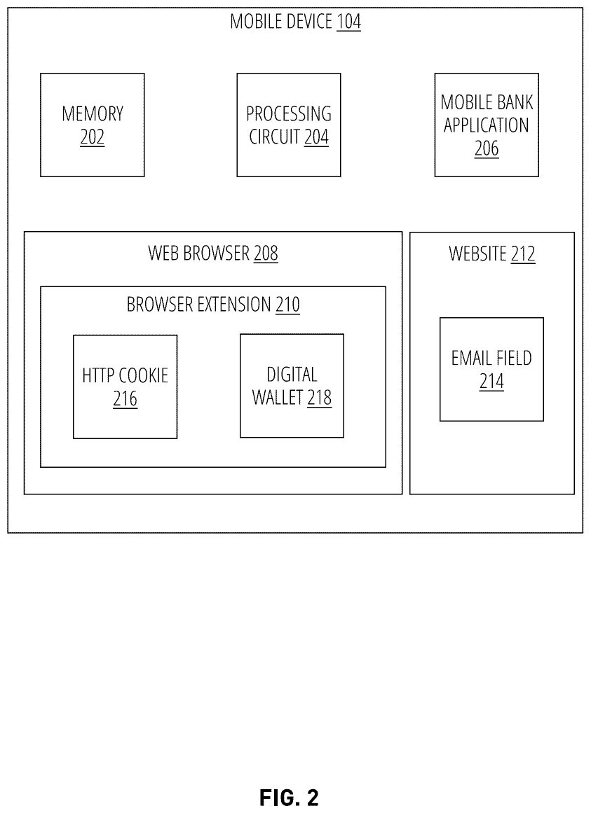

FIG. 2 is a block diagram illustrating an example computing device 104 according to some embodiments of the present disclosure. In some embodiments, the computing device 104 includes a memory 202 storing executable instructions thereon. The computing device 104 further includes a processing circuit to execute the instructions of the memory 202, which when executed, cause the processing circuit to perform various operations described herein.

In some embodiments, the computing device 104 has a web browser 208 installed thereon. For example, the web browser 208 can be a mobile version of the Safari web browser by Apple, Google Chrome by Alphabet, Mozilla Firefox or any other suitable browser. In some embodiments, the computing device 104 can communicate with a central application download store (e.g., App Store or Android App Store, Microsoft App Store, or any other suitable application download store) to download a mobile bank application 206 to communicate with the bank server 110. For example, the mobile bank application 206 can be a banking application that allows the user to access the bank account information from the bank server 110. In some other embodiments, the bank server 110 is a credit card company server and the mobile bank application 206 is a credit card application that provides the user access to their credit card account information. In some embodiments, instead of downloading the application from the app store, the mobile bank application 206 may be downloaded directly from the bank server 110. For example, in some embodiments the computing device 104 is another computing device such as a personal or desktop computer and the personal or desktop computer is configured to communicate with the bank server 110 to download the mobile bank application 206.

In some embodiments, the computing device is configured to automatically install a browser extension 210 on the web browser 208 operating on the computing device, the browser extension 210 being associated with a bank with which a user of the computing device has a banking account, the browser extension 210 enabling operation of a digital wallet associated with the bank to operate on the computing device. In some embodiments, the mobile bank application 206 and the browser extension 210 are downloaded and installed on the computing device substantially simultaneously. For example, in some embodiments the user can initiate a download of the mobile bank application 206 to install it on the computing device, and as part of the download of the mobile bank application 206, the browser extension 210 is also downloaded onto the web browser 208. In some cases, the browser extension 210 can be part of a file download package that comes with the mobile bank application 206 and as part of the sequence of downloading the mobile bank application 206, the browser extension 210 is also installed.

In addition to the browser extension 210 being installed, when the user enrolls in the multi-institution digital wallet extension, a temporary browser data file (e.g., an HTTP cookie 216) is also stored within the web browser 208 to permit the browser extension 210 to automatically populate at least one entry field described below with the personal data again at a future time. The HTTP cookie 216 (e.g., “temporary browser data file” or “browser data file”) can be generated by the bank server bank server 110 and shared with the browser extension 210, or the HTTP cookie (e.g., “temporary browser data file” or “browser data file”) can be generated by the centralized digital wallet server 114 and shared with the browser extension 210.

After the user has installed the browser extension 210 the user can set up one or more payment methods (e.g., credit cards) with the browser extension 210 that are sent to the centralized digital wallet server 114 to store and associated with the user's account to operate in the digital wallet 218. In some embodiments, the user may have multiple forms of payment saved and each one has a corresponding mobile bank application 206 associated there with. However, the browser extension 210 is only downloaded once when the first mobile bank application 206 is downloaded. The browser extension 210 is not installed each time a new mobile bank application 206 is installed.

In some embodiments, the computing device is configured to access a website 212 (e.g., hosted on the web server 108) via the web browser 208, the website 212 including a webpage having at least one entry field to be filled with data. For example, the website 212 can be a website for commercial transactions where the user can purchase goods and services online. The processing circuit 204 (e.g., one or more microprocessors and related components) is caused to enable operation of the digital wallet by activating the browser extension 210 on the web browser 208, the browser extension 210 being associated with the bank with which the user of the computing device has a banking account.

The website 212 includes a checkout page or checkout area or section that can include an email field 214 or any other entry field for which the user may be prompted to enter data. In some embodiments, the user selects the email field 214. Upon selecting the email field, the user is prompted by the browser extension 210 to indicate (e.g., via a user interface of the computing device 104) whether the user would like to use the browser extension 210 to execute the payment information for the checkout of the transaction. In response to the user indicating that they do want to use the browser extension 210 to perform the transaction (e.g., by selecting confirmation on the user interface of the computing device 104), the mobile bank application 206 is launched by the processing circuit 204.

When the browser extension 210 prompts the user to select whether they want to use the browser extension 210 to perform the transaction, the browser extension 210 is caused to display a prompt for the user to select a payment method form a list of one or more payment methods saved within the digital wallet 218. The one or more payment methods can include one or more payment options (e.g., credit or debit cards) that the user set up in the centralized digital wallet server 114. For example, the user is prompted to select, on a user interface of the computing device 104, a contactless card listed as one of one or more payment methods such as the one or more payment options described above. The user is directed to select one of the payment methods or credit cards that is saved on file at the centralized digital wallet server 114. The processing circuit 204 then receives, as input from the user via the user interface (not shown) of the computing device 104, a selection from the user for one of the payment methods.

Based on the payment method or credit card selected, the centralized digital wallet server 114 directs the browser extension 210 to cause the appropriate mobile bank application 206 to be launched. That is, the mobile bank application 206 that is executed or launched corresponds to the bank or issuer associated with the payment method selected by the user. For example, if a credit card issued by “ABC Bank” is selected by the user, the corresponding mobile bank application 206 for “ABC Bank” is launched. When the mobile bank application 206 is launched, step up occurs as described above. Additionally, the browser extension 210 receives an authentication token (e.g., oAuth token) via a URL from the bank server 110 (e.g., via or through the bank application). The authentication token is used by the browser extension 210 to make API requests on behalf of the user. The authentication token represents the authorization of a specific application (e.g., the browser extension 210) to access specific parts of a user's data (e.g., the user's personal data and any payment information from the centralized digital wallet server 114). That is the authentication token received by the browser extension 210 allows the browser extension 210 to make an API request to the centralized digital wallet server 114 to receive the PII and VCN or BVCN of the user for the account selected.

Before the authentication token can be received, one or more factor authentication may take place. For example a first authentication can include the mobile bank application 206 displaying a prompt to the user to enter the user's login credentials from the user. The user then enters their username (e.g., email address) and password inside the mobile bank application 206, which is received by the processing circuit 204, which validates the login credentials locally, or sends the login credentials to the authentication server 112 for validation. As another factor of authentication, the browser extension 210 can cause a one time passcode (OTP) to be sent via text message to a phone number associated with the user (e.g., a mobile device of the user). In some embodiments, the computing device 104 is configured to receive as user input into the web browser 208 or the browser extension 210 the OTP, and forward the OTP as the authentication data to the authentication server 112 for validation.

In another example, the processing circuit 204 is configured to prompt the user to authenticate an identity of the user by tapping their contactless card 102 to the computing device 104. In such an embodiment, the user can tap the contactless card 102 (e.g., from the list of payment methods) to the computing device 104, and the contactless card 102 can transmit, via an NFC exchange, encrypted data to the computing device 104. In some other embodiments, the authentication data can include biometric data or the like.

In some embodiments, the computing device 104 is configured to receive the authentication data from the user and then send the authentication data to an authentication server, such as authentication server 112. If the authentication data is a password or biometric data, the password or biometric data is validated by the authentication server 112. If the authentication data is encrypted data from the contactless card 102, the encrypted data is sent from the contactless card 102 to the computing device 104 via an NFC exchange as described herein. The encrypted data, such as that described in message 1300 is transmitted to the computing device 104 and then the computing device 104 forwards the encrypted data to the authentication server 112 for decryption and validation.

Once the authentication server 112 validates the encrypted data or biometric data from the contactless card 102 or computing device 104, the computing device 104 is configured to receive an indication from the authentication server 112 that the authentication data is verified. At this point, the mobile bank application 206 is still launched, but after receipt of an indication that that identity of the user is authenticated and the authentication token is received, the user is then redirected back to the web browser 208 and the website 212 where the checkout window is still waiting. The authentication token is then used by the browser extension 210, along with the HTTP cookie 216, to pull PII and BVCN from the centralized digital wallet server 114. For example, in some embodiments, the browser extension 210 sends a request to the centralized digital wallet server 114 for the PII and BVCN associated with the user. The authentication token is sent in the request and indicates which PII and BVCN should be pulled from the centralized digital wallet server 114 according to the payment method selected by the user.

For example, if the user selects the “ABC Bank” credit card, the authentication token received by the browser extension 210 and then sent in the request from the browser extension 210 to the centralized digital wallet server 114 for the PII and BVCN includes instructions for the centralized digital wallet server 114 to send the PII and BVCN corresponding to the “ABC Bank” payment method. The browser extension 210 then receives the PII and BVCN from the centralized digital wallet server 114. The browser extension 210 or the digital wallet 218 is then configured to automatically fill the at least one entry field (e.g., a payment field, shipping field, address field, etc.) with personal data (e.g., the PII and BVCN) associated with the user. For example, the browser extension 210 can automatically fill in payment information, shipping information, a name, phone number, or any other suitable data.

In some embodiments, the HTTP cookie 216 or browser data file is configured to permit the computing device 104 to automatically populate the at least one entry field with the personal data (e.g., PII and or BVCN) again in the future without requiring authentication of the identity of the user until the browser data file expires. For example the HTTP cookie 216 or browser data file can be configured to expire after 1 hour, 24 hours, one week, one month, three months, six months, a year, or any other suitable timeframe. In some embodiments, the temporary browser data file (e.g., the HTTP cookie) is bound to the website 212 and wherein the BVCN is also bound to the website 212 and both cannot be used by the browser extension 210 to populate fields associated with any other website.

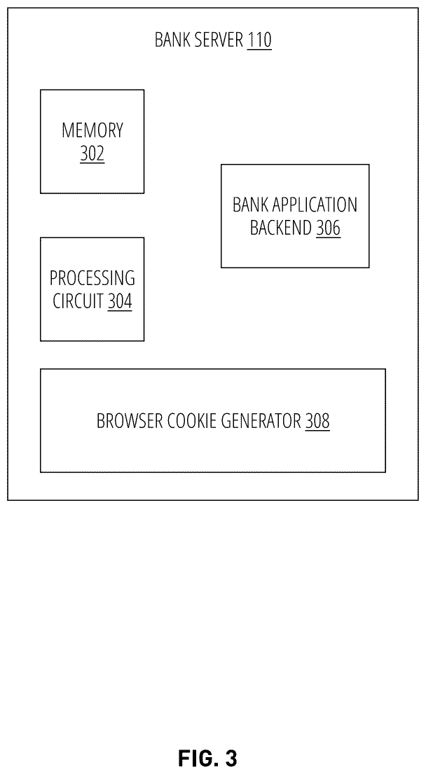

FIG. 3 illustrates a block diagram of an example bank server 110 according to some embodiments of the present disclosure. In some embodiments, the bank server 110 includes a memory 302 and processing circuit 304 to perform various operations described herein. For example, the bank server 110 hosts the bank application backend 306. When the user uses the mobile bank application 206 on the computing device 104, the data populated on the mobile bank application 206 is pulled from the bank server 110 for display. Also, when the user enrolls to operate the multi-institution digital wallet 218, this is performed at the bank server 110. The user will elect to enroll on the bank server 110.

In some embodiments, the bank server 110 includes a browser cookie generator 308. In some embodiments, the browser cookie generator 308 is a software module executed on the bank server 110 to generate the data file(s) that make up the browser HTTP cookie 216. In some embodiments, the browser cookie generator 308 generates the temporary browser data file (e.g., the HTTP cookie 216 described herein). As described above, in the mobile bank application 206, users can enroll in multi-institution digital wallet extension participation in an embedded web object (e.g., SafariController). This creates an HTTP cookie 216 that is shared with the external web browser 208 and the browser extension 210 that has been downloaded to function on the external web browser 208. This unique HTTP cookie 216 generated on enrolled devices creates device binding/trust for the user. The HTTP cookie 216 is unique in that it is a unique file containing data that associates the HTTP cookie 216 with only the computing device 104 operating the browser extension 210. The data associating the HTTP cookie 216 with only the computing device 104 operating the browser extension 210 can include a unique identifier that is associated with the computing device 104. Users who download the desktop version of the browser extension 210 complete a similar pattern to enroll after logging in with their bank credentials in the desktop browser and create a device HTTP cookie.

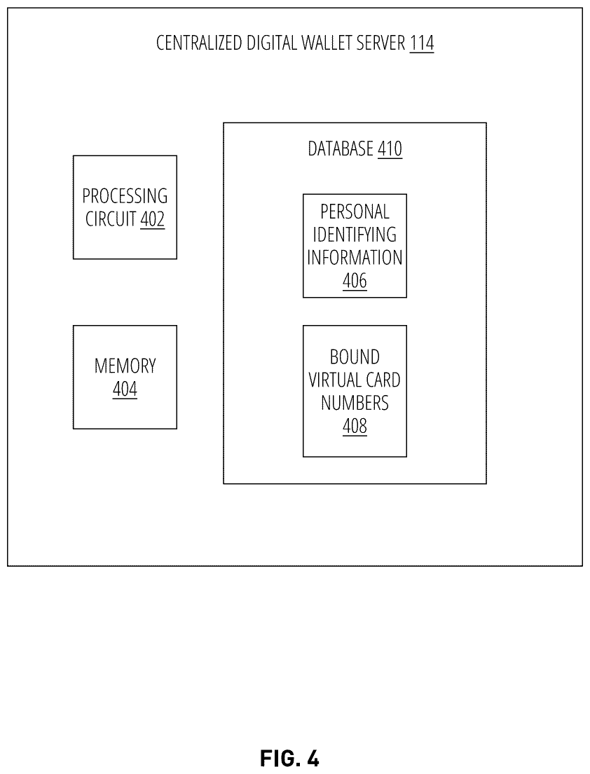

FIG. 4 is a block diagram of the centralized digital wallet server 114 according to some embodiments of the present disclosure. As shown in FIG. 4, the centralized digital wallet server 114 includes a processing circuit 402 and memory 404 to perform various operations described herein. In some embodiments, the centralized digital wallet server 114 is configured to communicate with the browser extension 210 to send personal data about the user if the authentication checks described herein are validated.

For example, in some embodiments, the centralized digital wallet server 114 includes a database 410 that has corresponding personal identifying information 406 and bound virtual card numbers 408 for each of the users enrolled, along with their respective payment methods, to utilize the browser extension 210. In some embodiments, when the user selects the payment method they want to use through the browser extension 210 and all the authentication steps are complete, the browser extension 210 uses the authentication token and HTTP cookie 216 to request the personal identifying information 406 and bound virtual card numbers 408 (e.g., associated with the payment option selected by the user) from the centralized digital wallet server 114. If the authentication token described above and the data from the HTTP cookie 216 match what the centralized digital wallet server 114 expects for the user's payment method, the centralized digital wallet server 114 sends the personal identifying information 406 and the bound virtual card numbers 408 to the browser extension 210 for the browser extension 210 to enter the personal identifying information 406 and bound virtual card numbers 408 into the website checkout fields.

For example, the personal identifying information 406 may include shipping information, a phone number, mailing address, or any other suitable personal identifying information 406. This information can be sent to the browser extension 210 for the browser extension 210 to auto-fill the appropriate fields on the checkout page at the website 212. Similarly, the bound virtual card numbers 408 can be used to enter into the payment fields of the checkout page at the website 212.

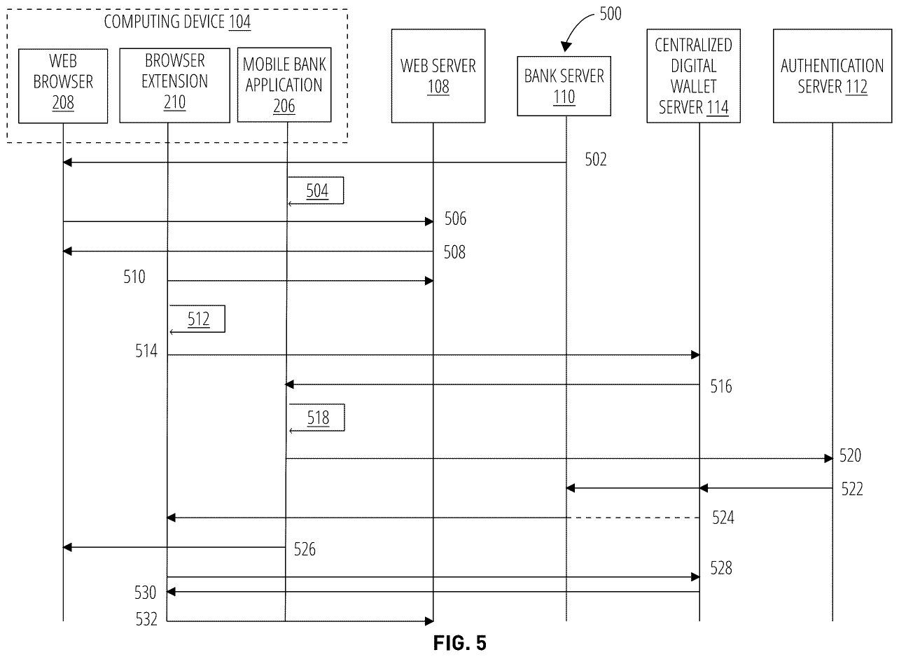

FIG. 5 is a sequence flow 500 diagram illustrating a possible sequence of events for executing a multi-institution digital wallet browser extension according to some embodiments. This sequence flow 500 provides one example of how the browser extension 210 for generating and using the multi-institution digital wallet is downloaded and used.

As shown at 502, the browser extension 210 is downloaded from either the bank server 110 or a mobile device app store. In some embodiments, the browser extension 210 is downloaded and installed substantially simultaneously with the mobile bank application 206. For example, a package that includes the mobile bank application 206 and the browser extension 210 can be downloaded and installed simultaneously or sequentially.

After the browser extension 210 is installed, at 504, the user of the computing device 104 is prompted on the mobile bank application 206 to enroll in the multi-institution digital wallet. In some embodiments, enrollment includes the user entering information (e.g., credit card numbers, expiration dates, billing addresses, CVC codes, etc.) for one or more methods of payment (e.g., one or more credit or debit cards, checking account, savings account, gift card, etc.) into the multi-institution digital wallet. During enrollment, the enrolled payment method data is sent to the centralized digital wallet server 114 for storage. an temporary browser data file, also referred to as an HTTP cookie, is shared with the web browser 208 to store for executing transactions with the digital wallet browser extension 210. The enrollment is generated in an embedded web object, such as a SafariController embedded web object, and this creates the HTTP cookie. The unique temporary browser data file, or HTTP cookie, created on enrolled devices creates device binding/trust for the computing device 104 and the user's account. Users who download the desktop version of the browser extension 210 complete a similar pattern to enroll after logging in with their bank credentials in the desktop browser and creating a device HTTP cookie.

Once the HTTP cookie is installed, at any point in time thereafter, at 506, the user may navigate to a webpage by sending a request to download the webpage to the web server 108. At 508, the web server 108 sends the website data to the computing device 104 and the web browser 208 loads the webpage and displays it to the user. The website may include an online merchant website, retailer, service provider, or any other website which includes a checkout page for purchasing goods or services and where payment and other personal information is to be inserted into fields of the website. In some embodiments, the user may click (e.g., using a mouse or their finger on a touchscreen such as a mobile phone, tablet PC, or some other computing device) a field of a checkout area of the website. For example, the field may be an email field 214 like that shown in FIG. 2. The field may also be a username field, a phone number field, a shipment field, a payment field, or any other field that would appear on a checkout area of a merchant website.

At 510, the browser extension injects Javascript into the website causing the website to display a prompt on the website to invite the user to select and use the digital wallet through the browser extension 210. At 512, the user accepts the invitation to use the digital wallet via the browser extension 210 and selects, via a user interface (e.g., touchscreen on their mobile device, mouse, keyboard, stylus, etc.) a payment method from a list of payment methods displayed by the browser extension 210. At 514, the browser extension 210 sends the selection that the user made of the payment method to the centralized digital wallet server 114.

The centralized digital wallet server 114 performs decisioning to determine which mobile bank application 206 the computing device 104 should launch in order to proceed. The centralized digital wallet server 114 determines which mobile bank application 206 the computing device 104 should launch based on the payment method selected by the user and then at 516 sends a message to the computing device 104 indicating which mobile bank application 206 to launch. For example, if a payment method including a credit card for “ABC Bank” is selected, the centralized digital wallet server 114 will send a message to the contactless card 102 to launch the “ABC Bank” mobile bank application 206 that is downloaded on the user's computing device 104.

At 518 the appropriate mobile bank application 206 is launched on the computing device 104 and displayed to the user. Step up occurs, as described above, and the user is prompted to enter their login credentials on the mobile bank application 206. In addition to the login credentials, the user may be prompted to perform multifactor authentication as described above. This may include the user receiving a one-time passcode (OTP) from the bank server 110. This may also include tapping their contactless card to the computing device 104 to send encrypted data to the computing device 104 as described herein. The encrypted data is then sent to the authentication server 112. Multi-factor authentication may also include biometric validation. Based on the multi-factor authentication method, the user enters the OTP into the mobile bank application 206, taps their contactless card, or provides their biometric data to the mobile bank application 206 and at 520, this data is sent to the authentication server 112 for validation. At 522, the authentication server 112 performs the validation of the authentication data sent by the user and an indication is sent by the authentication server 112 to either or both of the centralized digital wallet server 114 and the bank server 110 indicating that the authentication data of the user has been validated.

At 524, either the centralized digital wallet server 114 or the bank server 110 sends an authorization token (e.g., an oAuth token described herein) to the browser extension 210 via a URL. At 526, the computing device 104 then redirects the user (e.g., via the display on the computing device 104) back to the web browser 208. That is, the computing device 104 causes the screen or application being displayed by the computing device 104 to switch back from the mobile bank application 206 to the web browser 208 with the checkout page.

At 528, the browser extension 210 sends a request to the centralized digital wallet server 114 for personal identifying information (PII) of the user, including a virtual card number or a bound virtual card number to be entered into the checkout fields of the checkout page of the website. The request from the browser extension 210 includes the authentication token and the temporary browser data file (e.g., the HTTP cookie that created trust between the web browser 208 or browser extension 210 and the centralized digital wallet server 114). At 530, the centralized digital wallet server 114 processes the request, including inspecting the authentication token and the browser data file. Based on the payment method to which the authentication token corresponds, the centralized digital wallet server 114 queries a database for the appropriate PII and BVCN corresponding to the payment method in the authentication token and sends the PII and BVCN to the browser extension 210. At 532, the browser extension 210 then enters the PII and BVCN in the relevant payment and shipment or personal information fields of the checkout page for the merchant website. The transaction can then be completed with the payment and personal information being entered in a secure manner without the user having to grab their wallet or credit card.

The BVCN is bound to a particular merchant and cannot be used at any other merchant or merchant website. In some embodiments, the BVCN is bound to one or more categories of merchants. For example, a BVCN can be bound to only grocery stores, and therefore can only be used at merchants listed as grocery stores at the bank. In some other embodiments, the BVCN can be bound to other types of merchants such as restaurants, sports venues, online retailers, etc. In these cases, the corresponding BVCN can only be used with merchants that are identified as that type of merchant with the bank. The browser extension 210 can also be used by customers to complete a merchant's card-on-file onboarding process, by populating the payment credential fields with the BVCN and the customer info fields with the PII data from their bank. After a customer uses the browser extension 210 on their mobile or desktop device for the first time, an HTTP cookie is created by centralized digital wallet server 114 and stored within the web browser 208 of that device to recognize the customer and allow future auto-fill for that specific card and website without requiring the authentication steps described above.

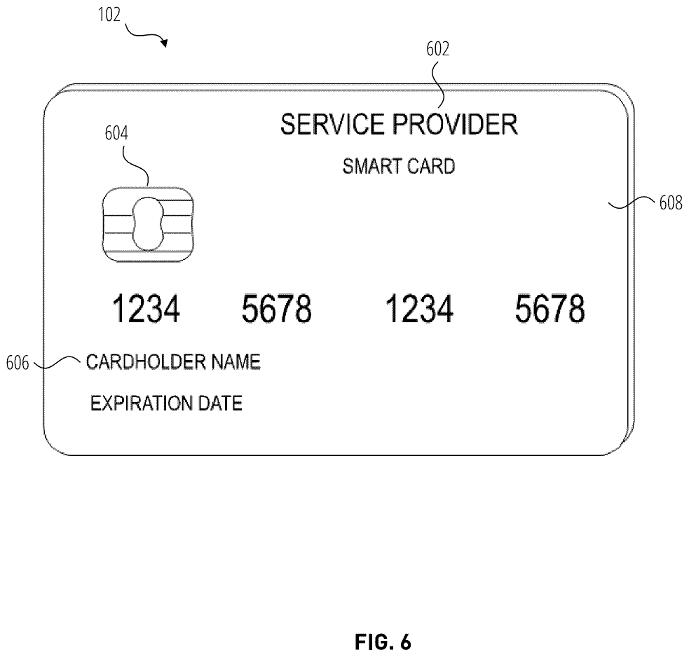

FIG. 6 illustrates an example configuration of a contactless card 102, which may include a contactless card, a payment card, such as a credit card, debit card, or gift card, issued by a service provider as displayed as service provider indicia 602 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 608, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

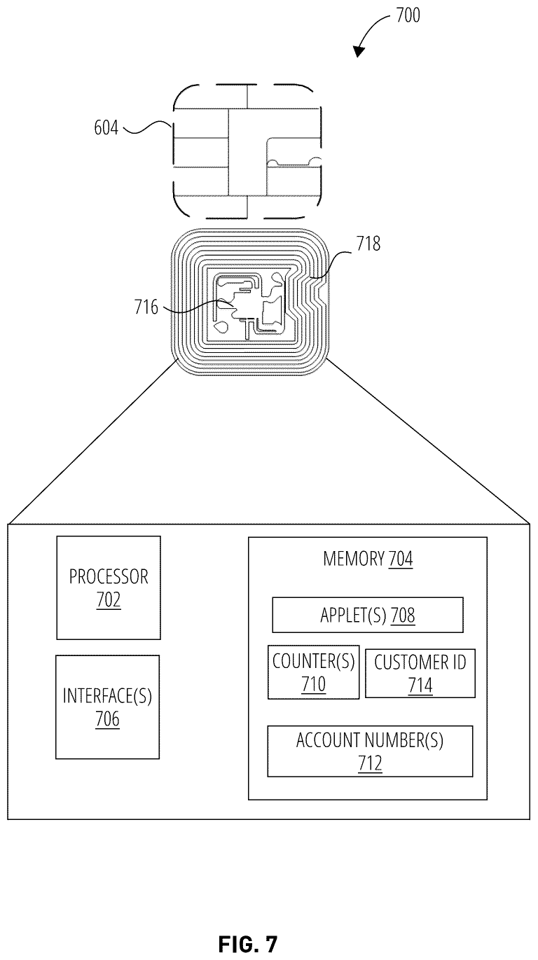

The contactless card 102 may also include identification information 606 displayed on the front and/or back of the card, and a contact pad 604. The contact pad 604 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 7. These components may be located behind the contact pad 604 or elsewhere on the substrate 608, e.g. within a different layer of the substrate 608, and may electrically and physically coupled with the contact pad 604. The contactless card 102 may also include a magnetic strip or tape, which may be located on the back of the card (not shown in FIG. 6). The contactless card 102 may also include a Near-Field Communication (NFC) device coupled with an antenna capable of communicating via the NFC protocol. Embodiments are not limited in this manner.

As illustrated in FIG. 6, the contact pad 604 of contactless card 102 may include processing circuitry 716 for storing, processing, and communicating information, including a processor 702, a memory 704, and one or more interface(s) 706. It is understood that the processing circuitry 716 may contain additional components, including processors, memories, error and parity/CRC checkers, data encoders, anticollision algorithms, controllers, command decoders, security primitives and tamperproofing hardware, as necessary to perform the functions described herein.

The memory 704 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 704 may be encrypted memory utilizing an encryption algorithm executed by the processor 702 to encrypted data.

The memory 704 may be configured to store one or more applet(s) 708, one or more counter(s) 710, a customer identifier 714, and the account number(s) 712, which may be virtual account numbers. The one or more applet(s) 708 may comprise one or more software applications configured to execute on one or more contactless cards, such as a Java® Card applet. However, it is understood that applet(s) 708 are not limited to Java Card applets, and instead may be any software application operable on contactless cards or other devices having limited memory. The one or more counter(s) 710 may comprise a numeric counter sufficient to store an integer. The customer identifier 714 may comprise a unique alphanumeric identifier assigned to a user of the contactless card 102, and the identifier may distinguish the user of the contactless card from other contactless card users. In some examples, the customer identifier 714 may identify both a customer and an account assigned to that customer and may further identify the contactless card 102 associated with the customer's account. As stated, the account number(s) 712 may include thousands of one-time use virtual account numbers associated with the contactless card 102. An applet(s) 708 of the contactless card 102 may be configured to manage the account number(s) 712 (e.g., to select an account number(s) 712, mark the selected account number(s) 712 as used, and transmit the account number(s) 712 to a mobile device or a computing device 104 for autofilling by an autofilling service.

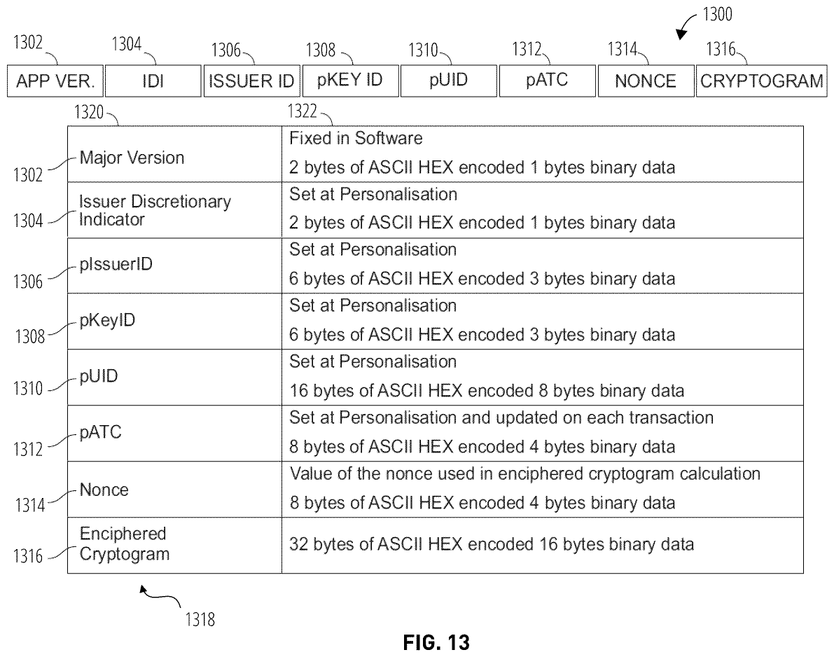

In some embodiments, the memory 704 can include (e.g., have stored therein) the data from the fields shown in FIG. 7 and/or FIG. 13. The processor 702 can then use the data from the fields to generate the message 1300 as described above.

The processor 702 and memory elements of the foregoing exemplary embodiments are described with reference to the contact pad 604, but the present disclosure is not limited thereto. It is understood that these elements may be implemented outside of the contact pad 604 or entirely separate from it, or as further elements in addition to processor 702 and memory 704 elements located within the contact pad 604.

In some examples, the contactless card 102 may comprise one or more antenna(s) 718. The one or more antenna(s) 718 may be placed within the contactless card 102 and around the processing circuitry 716 of the contact pad 604. For example, the one or more antenna(s) 718 may be integral with the processing circuitry 716 and the one or more antenna(s) 718 may be used with an external booster coil. As another example, the one or more antenna(s) 718 may be external to the contact pad 604 and the processing circuitry 716.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 718, processor 702, and/or the memory 704, the contactless card 102 provides a communications interface to communicate via NFC, Bluetooth, and/or Wi-Fi communications.

As explained above, contactless card 102 may be built on a software platform operable on smart cards or other devices having limited memory, such as JavaCard, and one or more or more applications or applets may be securely executed. Applet(s) 708 may be added to contactless cards to provide a one-time password (OTP) for multifactor authentication (MFA) in various mobile application-based use cases. Applet(s) 708 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 708 may be configured to encode the OTP as an NDEF type 4 well known type text tag. In some examples, NDEF messages may comprise one or more records. The applet(s) 708 may be configured to add one or more static tag records in addition to the OTP record.

In some examples, the one or more applet(s) 708 may be configured to emulate an RFID tag. The RFID tag may include one or more polymorphic tags. In some examples, each time the tag is read, different cryptographic data is presented that may indicate the authenticity of the contactless card. Based on the one or more applet(s) 708, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 710 may be configured to increment. In some examples, each time data from the contactless card 102 is read (e.g., by a mobile device), the counter(s) 710 is transmitted to the server for validation and determines whether the counter(s) 710 are equal (as part of the validation) to a counter of the server.

The one or more counter(s) 710 may be configured to prevent a replay attack. For example, if a cryptogram has been obtained and replayed, that cryptogram is immediately rejected if the counter(s) 710 has been read or used or otherwise passed over. If the counter(s) 710 has not been used, it may be replayed. In some examples, the counter that is incremented on the card is different from the counter that is incremented for transactions. The contactless card 102 is unable to determine the application transaction counter(s) 710 since there is no communication between applet(s) 708 on the contactless card 102.

In some examples, the counter(s) 710 may get out of sync. In some examples, to account for accidental reads that initiate transactions, such as reading at an angle, the counter(s) 710 may increment but the application does not process the counter(s) 710. In some examples, when the computing device 104 is woken up, NFC may be enabled and the computing device 104 may be configured to read available tags, but no action is taken responsive to the reads.

To keep the counter(s) 710 in sync, an application, such as a background application, may be executed that would be configured to detect when the mobile computing device 104 wakes up and synchronize with the server of a banking system indicating that a read that occurred due to detection to then move the counter(s) 710 forward. In other examples, Hashed One Time Password may be utilized such that a window of mis-synchronization may be accepted. For example, if within a threshold of 10, the counter(s) 710 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 710 increases in the appropriate sequence, then it possible to know that the user has done so.

The key diversification technique described herein with reference to the counter(s) 710, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

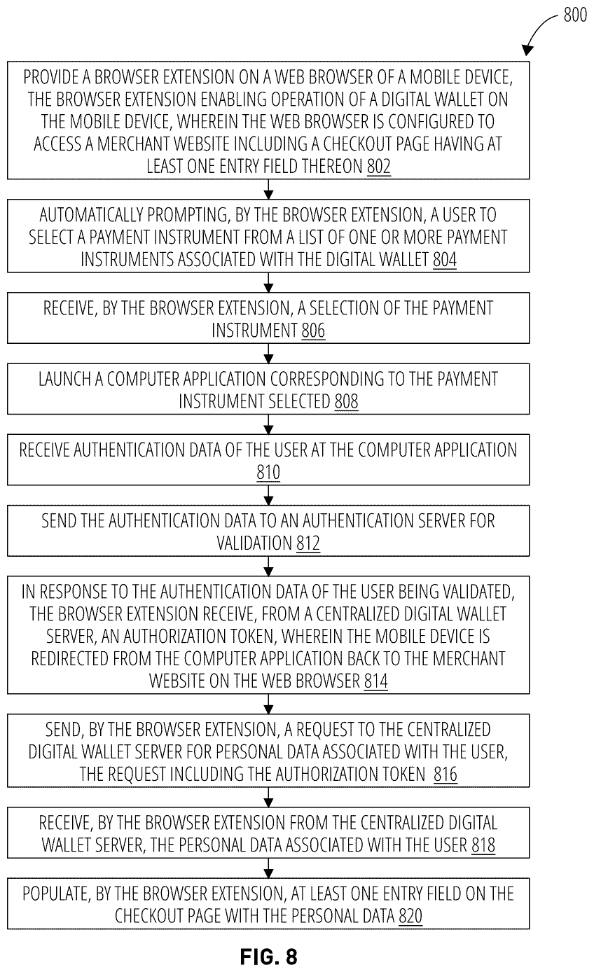

FIG. 8 is a flow chart illustrating some operations of an example method 800 for multi-institution digital wallet browser extension. As shown at block 802, method 800 includes providing a browser extension on a web browser of a mobile device, the browser extension enabling operation of a digital wallet on the mobile device, wherein the web browser is configured to access a merchant website including a checkout page having at least one entry field thereon. As shown at block 804, the method 800 includes automatically prompting, by the browser extension, a user to select a payment instrument from a list of one or more payment instruments associated with the digital wallet. As shown at block 806, the method 800 includes receiving, by the browser extension, a selection of the payment instrument. As shown at block 808, the method 800 includes launching a computer application corresponding to the payment instrument selected. As shown at block 810, the method 800 includes receiving authentication data of the user at the computer application. As shown at block 812, the method 800 includes sending the authentication data to an authentication server for validation.

As shown at block 814, the method 800 includes, in response to the authentication data of the user being validated, the browser extension receiving, from a centralized digital wallet server, an authorization token, wherein the mobile device is redirected from the computer application back to the merchant website on the web browser. As shown at block 816, the method 800 includes sending, by the browser extension, a request to the centralized digital wallet server for personal data associated with the user, the request including the authorization token. As shown at block 818, the method 800 includes receiving, by the browser extension from the centralized digital wallet server, the personal data associated with the user. As shown at block 820, the method 800 includes populating, by the browser extension, at least one entry field on the checkout page with the personal data.

In some embodiments, providing the browser extension includes automatically installing the browser extension simultaneously with the computer application being installed on the mobile device. In some embodiments, the computer application is a mobile banking application or a mobile credit card issuer application. In some embodiments, the method further includes prompting the user to enter login credentials into the computer application, the login credentials being one factor of authentication data received at the computer application. In some embodiments, the browser extension receiving the authorization token includes the browser extension receiving a universal resource locator (URL), the URL including the authorization token.

In some embodiments, receiving authentication data of the user includes prompting the user to tap a contactless card listed as one of the one or more payment instruments to the mobile device, the method further comprising: receiving encrypted data from the contactless card, wherein the authentication data is the encrypted data; and sending the encrypted data to the authentication server to validate the encrypted data and identity of the user. In some embodiments, receiving authentication data of the user includes receiving a text message with a one-time passcode. In some embodiments, the method further comprises receiving the one-time passcode in the computer application and sending the one-time passcode as the authentication data to the authentication server to verify the one-time passcode.

In some embodiments, the method further includes sending the web browser a temporary browser data file to store within the web browser to permit the browser extension to automatically populate the at least one entry field with the personal data again at a future time. In some embodiments, the browser data file permits the browser extension to automatically populate the at least one entry field with the personal data at the future time without requiring authentication of the identity of the user until the browser data file expires.

In some embodiments, the browser data file is generated by the centralized digital wallet server or a server in communication with the computer application, the server acting as an application backend pair with the computer application and the browser data file is bound to the merchant. In some embodiments, the personal data associated with the user includes a bound virtual card number (BVCN) associated with the payment instrument or personal identification information (PII) of the user. In some embodiments, the BVCN is bound to the merchant and cannot be used by the browser extension to populate fields associated with any other merchant or website.

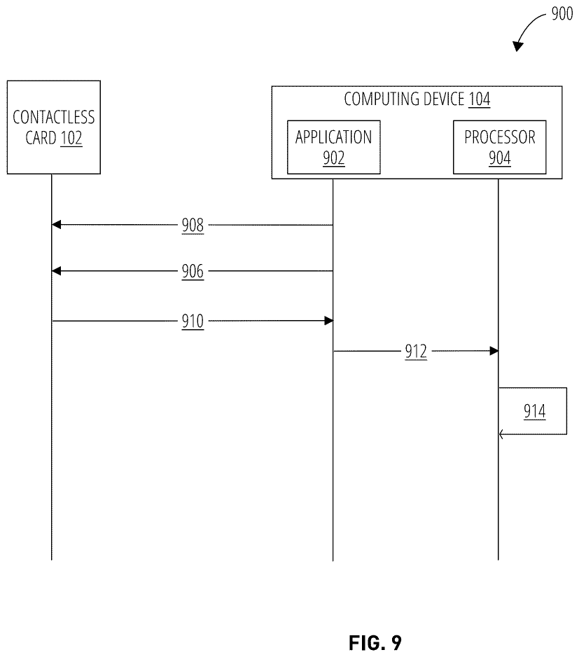

FIG. 9 is a timing diagram illustrating an example sequence for providing authenticated access according to one or more embodiments of the present disclosure. Sequence flow 900 may include contactless card 102 and computing device 104, which may include an application 902 and processor 904. The steps described in this sequence flow 900 provide one example in which encrypted data is passed from the contactless card 102 to the computing device 104. The encrypted data can be used to perform multi-factor authentication, as described above.

At line 908, the application 902 communicates with the contactless card 102 (e.g., after being brought near the contactless card 102). Communication between the application 902 and the contactless card 102 may involve the contactless card 102 being sufficiently close to a card reader (not shown) of the computing device 104 to enable NFC data transfer between the application 902 and the contactless card 102.

At line 906, after communication has been established between computing device 104 and contactless card 102, contactless card 102 generates a message authentication code (MAC) cryptogram. In some examples, this may occur when the contactless card 102 is read by the application 902. In particular, this may occur upon a read, such as an NFC read, of a near field data exchange (NDEF) tag, which may be created in accordance with the NFC Data Exchange Format. For example, a reader application, such as application 902, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 902 may be configured to transmit a request to contactless card 102, the request comprising an instruction to generate a MAC cryptogram.

At line 910, the contactless card 102 sends the MAC cryptogram to the application 902. In some examples, the transmission of the MAC cryptogram occurs via NFC, however, the present disclosure is not limited thereto. In other examples, this communication may occur via Bluetooth, Wi-Fi, or other means of wireless data communication. At line 912, the application 902 communicates the MAC cryptogram to the processor 904.

At line 914, the processor 904 verifies the MAC cryptogram pursuant to an instruction from the application 902. For example, the MAC cryptogram may be verified, as explained below. In some examples, verifying the MAC cryptogram may be performed by a device other than computing device 104, such as a server of a banking system in data communication with the computing device 104. For example, processor 904 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

FIG. 10 illustrates an example of system 1000 in accordance with the embodiments discussed herein. The system 1000 includes additional devices and systems configured to enable contactless card issuers to tap-to-card services. Specifically, system 1000 enables any number of issuer systems to provide card services to their clients through a switching fabric, i.e., the switchboard system in a secure and safe manner. This system 1000 can be used to transmit the encrypted data from the contactless card 102 to the authentication server 112 for validation. In some embodiments, the authentication server 112 of FIG. 1 can be embodied by one of the nodes 1004 in FIG. 10.

In embodiments, the switchboard system includes one or more nodes 1004 configured to perform routing operations. Each switchboard node 1004 may include a session and nonce generator 1006, a message router 1008, an authentication 1010, an operation data 1012 store, and a metrics store 1014. Further, each of the nodes may be configured the same and share configurations, but each switchboard node 1004 may independently process and route messages and requests to the appropriate systems, such as the merchant systems and issuer systems. Each of the nodes 1004 is configured to act as a broker of trust between an issuer system, the merchant system 1022, and/or validation system 1024, for example. Each switchboard node 1004 is configured to route each message to the correct issuer system while maintaining data security. For example, a switchboard node 1004 may route a message between an issuer system and a merchant system while the node cannot access the private data in the message.

The switchboard system 1000 may be configured as a server system with a collection of hardware, software, and networking components that work together to provide client services. Hardware components may include one or more server computers, storage devices, and network adapters. The server computers are configured to run server applications, such as those executable on each of the nodes 1004. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

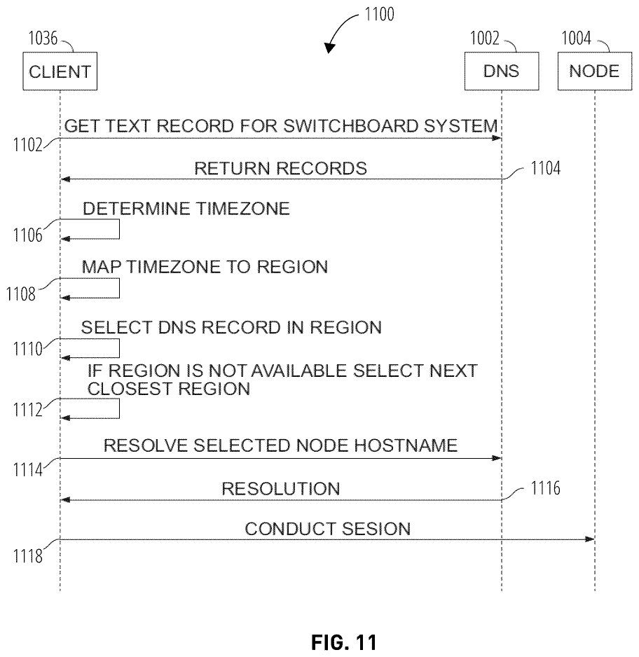

In some embodiments, the nodes 1004 may operate in a cloud-based computing environment, e.g., a collection of hardware, software, and networking components that enable the delivery of cloud computing services. The switchboard nodes 1004 and the computing services are delivered over the Internet and can be accessed from anywhere in the world with an Internet connection. In embodiments, client 1036 may access a switchboard node 1004 through DNS 1002 or Domain Name System (DNS). The DNS 1002 is a hierarchical and distributed naming system for computers, services, and other resources connected to the Internet or other networks. It associates various information with domain names assigned to each registered participant. In one example, the DNS 1002 may translate a name known to software executing on a client 1036 to route data to one or more of switchboard node 1004 of the switchboard system. In embodiments, the DNS 1002 may generate a number, such as an Internet Protocol (IP) address, an address record (A-record), or another Hostname (C-name record). FIG. 11 illustrates one example sequence 1100 for a client to identify and resolve an identifier for one of the nodes 1004 of the switchboard system. At a high level, the DNS 1002 translates known domain names to numerical Internet Protocol (IP) addresses needed for locating and identifying computer services and devices with the underlying network protocols. Clients use the global DNS system to select the best node to use, as discussed in sequence 1100.

In embodiments, a client 1036 communicates with the switchboard system to perform one or more of the partner services 1032, such as conducting a transaction with a merchant, validating the customer, or other tap-to functions. Once client 1036 identifies a switchboard node 1004 and resolves an address to communicate with switchboard node 1004, client 1036 may send one or more messages to switchboard node 1004 to authenticate and perform the operation. The switchboard node 1004 includes an authentication 1010 function that is configured to authenticate the client 1036. In embodiments, the client 1036 sends a message or authorization request to the switchboard node 1004 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

The switchboard node 1004 may authorize or authenticate the client 1036 or user, and the switchboard node 1004 may utilize the additional components, such as the session and nonce session and node generator 1006 and message router 1008, to perform the operations. Note the validation systems validation system 1024 never interact with the merchant systems 1022, nor vice versa. The nodes node 1004 brokers all communication.

In embodiments, the switchboard system may utilize a hyper ledger fabric 1020 to manage to synchronize the shared operation data 1012 and member management across the network. The hyperledger fabric 1020 is distributed ledger framework having a permissioned network model that only authorized participants can join the network and access the data that is stored on a ledger.

In embodiments, the hyperledger fabric 1020 may be generated by creating one or more sets of peers, an ordering service, and a channel. Once the network is created, system 1000 deploys chaincode to the network, or node 1004 is permitted to access the fabric. The chaincode is the code that runs on the blockchain and executes the network control 1026 and operation data 1012 logic code. Once the chaincode is deployed, each of the switchboard nodes 1004 is configured to invoke transactions on the blockchain to add data to the blockchain, e.g., the operational data. A switchboard node 1004 or another device can query the ledger to retrieve data. The ledger is a distributed database that stores all the data added to the blockchain.

All nodes 1004 keep an independently verifiable log of their actions that can be transmitted to a centralized aggregator to build a picture of overall network usage. System 1000 can manage network operation data and management at a central level and have a centralized view of network use, aggregated and abstracted to the appropriate level.

FIG. 11 illustrates an example sequence 1100 for a client to utilize DNS to resolve and communicate with one or more nodes of a switchboard system 1000 in FIG. 10. The illustrated sequence 1100 includes a client 1036, a DNS 1002, and a switchboard node 1004. At 1102, the sequence 1102 includes the client 1036 sending a request to a default DNS server for a text record switchboard.{domain}.{tld}. The text record may be preconfigured in a client app and/or client SDK. At 1104, the DNS 1002 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii}.switchboard.{domain}.{tld},
      * etc.
   Used For determining where there are active nodes
Node Record:
   Name: {nodename}.{operator}.{region}.switchboard.{domain}.{tld}
   Type: A/AAAA or CNAME
   Resolution: Actual node hostname or IP
   Used For: communicating with a node 1004

In embodiments, the client 1036 may determine the current timezone at 1106. For example, the client app or SDK may utilize a get current timezone function, such as in JavaScript: Intl.DateTimeFormat( ).resolvedOptions( ).timeZone). Embodiments are not limited in this manner, and the app or sdk may determine the timezone via another/different function call. At 1108, the client 1036 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_{——}York | North America/East | na-e |
| America/Buenos_{——}Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1110, the client 1036 may identify or select a DNS record option returned at 1104 that is in the region. If there are multiple matches, the client 1036 may select one at random. If there's no node available in a region, the client 1036 may determine and use a data graph of neighboring regions to select a node in the closest region where a node is available at 1112. For example, sa has no node but is connected to na-e where there is a node and so na-e is selected. In some embodiments,

At 1114, the client may resolve a selected node's hostname. In embodiments, the client 1036 may automatically resolve the hostname using the client's HTTP request default resolver. At 1116, the DNS 1002 may return a result. And at 1118, the client 1036 may communicate with a switchboard node 1004 and begin the process to interact with the switchboard.

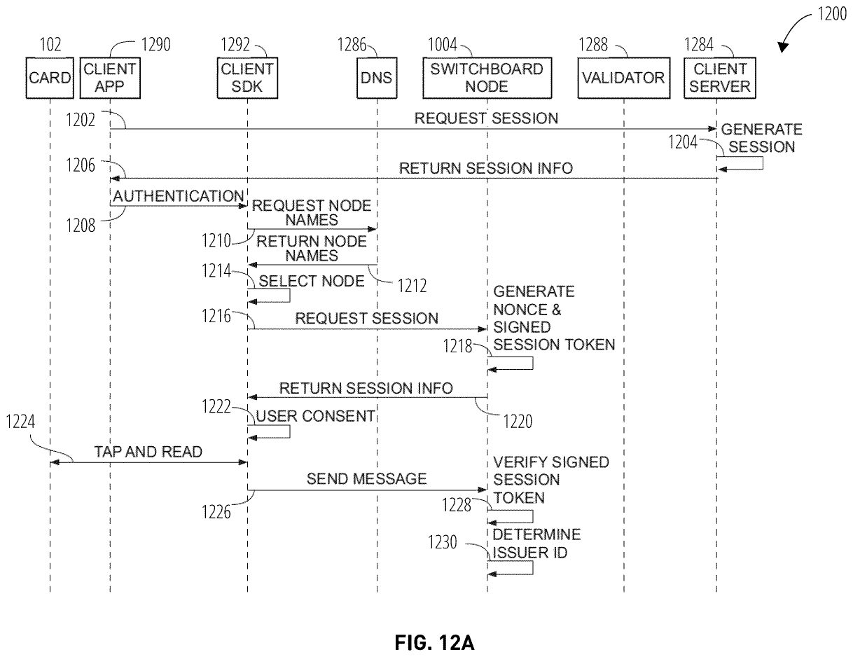

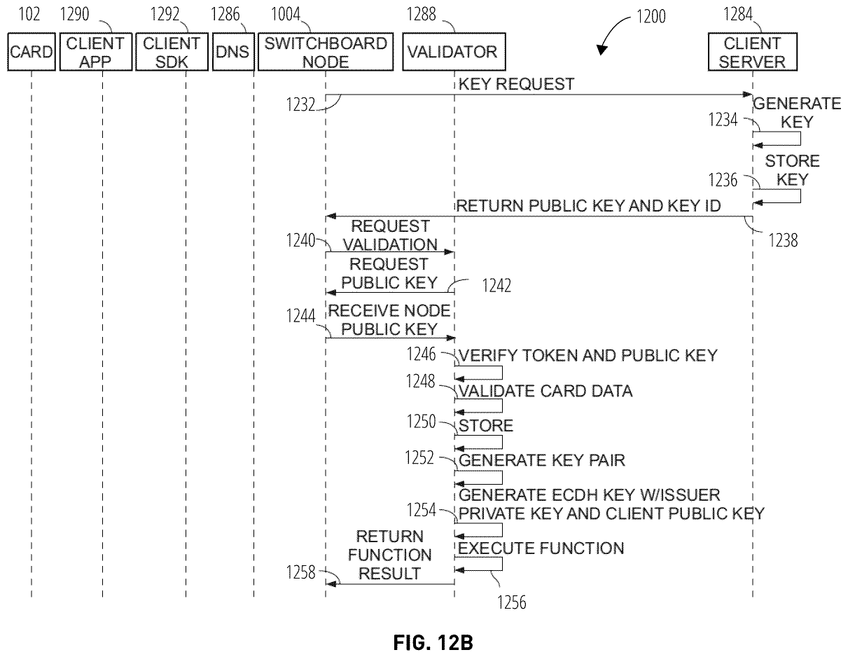

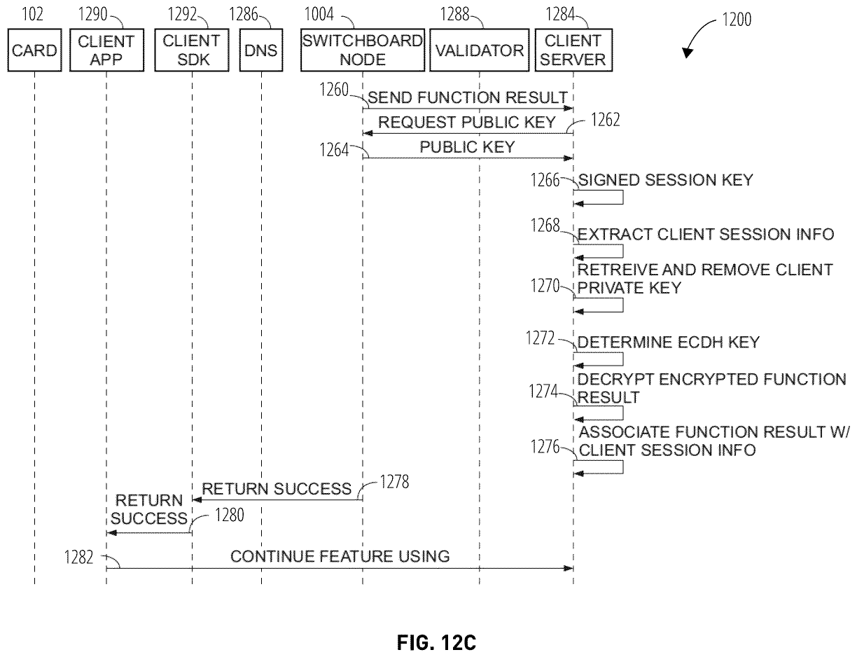

FIG. 12A-FIG. 12C illustrate an example sequence 1200 to perform operations between a contactless card 102 and services provided by a card issuer and/or merchant. The illustrated sequence 1200 includes actions and communications performed by a contactless card 102, a client 1036 including a client app 1290 and a client SDK 1292, a DNS 1286, a switchboard system including one or more nodes 1004, a partner services 1032 including a merchant and/or validator 1288, and control services 1034 including a client server 1284 or system. In embodiments, the client app 1290 may be any application configured to execute on a client 1036, such as a banking app, a merchant app, a social media app, a travel app, a gaming app, a productivity app, an entertainment app, and so forth. In embodiments, the client app 1290 includes a web browser to provide websites and pages. The client app 1290 may include and/or utilize the client SDK 1292, which may be a set of instructions that enable the client app 1290 to communicate with other components of the switchboard system.

In embodiments, as shown in FIG. 12A, at 1202 the client 1036 including the client app may send a request and establish a session with a client server 1284 such that a result may be associated with the correct client device or user. The request establishes a relationship between the client device and client server, which may be an issuer server. At 1204, the client server 1284 generates a session and CLIENT SESSION INFORMATION. At 1206, the client server 1284 returns the session information, e.g., the CLIENT SESSION INFORMATION. In embodiments, the CLIENT SESSION INFORMATION may be the Client implementation-specific user session identification information.

At 1208, the client 1036 may initiate a contactless card authentication process with the client 1036. For example, the client 1036 may call a function and/or pass information to the client 1036 to initiate authentication via a contactless card 102. At 1210-1214, the client 1036 may utilize DNS to identify a node and establish communication with the node. Specifically, at 1210, the client 1036 including the client SDK 1292 may send a request for switchboard hostnames, and at 1212 the the DNS 1286 may return information including one or more hostnames. At 1214, the client 1036 may determine a switchboard node to communicate. FIG. 11 illustrates an example of a more detailed sequence of the process to establish communication with a switchboard node 1004.

At 1216, the client 1036 may send a request for a session to the switchboard system 1000. In embodiments, the request for a session may be for a function request in the format <FUNCTION REQUEST>. In embodiments, the FUNCTION REQUEST may be the data/function that the client 1036 would like to request once a contactless card 102 has been validated. The function could be for any service discussed herein, e.g., authenticate the user, perform a transaction, request autofill data, etc. At 1218, switchboard system 1000 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST> signed with <NODE PRIVATE KEY>, where the NODE PRIVATE KEY is the switchboard system 1000 private key. The switchboard system 1000 may include a NODE PUBLIC/PRIVATE KEY, which is a keypair used to sign and validate JWTs.

At 1220, the switchboard system 1000 may return session information to the client 1036. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1222, the client SDK 1292 may determine and/or receive user consent to the terms of service. In one example, the client SDK 1292 captures and records the user consent to <FUNCTION TOS> on <CONSENT DATE> with <TOS VERSION>. The CONSENT DATE may be the timestamp for the user's consent to the TOS.

At 1224, the client 1036 exchanges one or more messages with a contactless card. In one example, the exchange may be based on the contactless card being tapped to a client device. In embodiments, the client SDK 1292 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . | NONCE | 8 bytes of ASCII HEX encoded 4 bytes |
| 0E | | binary data |
| 0F . . . | Session | 4 bytes of ASCII HEX encoded 2 bytes |
| 12 | Indicators | binary data |
| 13 . . . | Control | 4 bytes of ASCII HEX encoded 2 bytes |
| 16 | Indicators | binary data |
| 17 . . . | Update Date | 16 bytes of ASCII HEX encoded 8 bytes |
| 26 | creation Time | binary data - represents 64 bit unix |
| | | timestamp |
| 27 . . . | Update MAC | MAC to protect control indicators - 16 bytes |
| 36 | | of ASCII HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 13, message 1300.

At 1224, the contactless card may generate and provide a message to the client's device including the client SDK 1292. The data in the message may be utilized by the system discussed herein to perform the function requested. One example of the message is illustrated and discussed in FIG. 13, message 1300.

At 1226, the client including the client SDK 1292 may send a message and information to the switchboard system 1000. The message may be the message received from the contactless card 102, e.g., message 1300. In addition, the client SDK 1292 may send the consent date, the TOS version, and the signed session token to the switchboard system 1000. The switchboard system 1000 may utilize the information to ensure the session is valid. At 1228, the switchboard system 1000 verifies the signed session token is valid, e.g., is the previously provided signed session token and includes the nonce previously generated and is in the message.

In some embodiments, the switchboard system 1000 is configured to determine which issuer system or client-server it should route the message to for processing. At 1230, the switchboard system 1000 may determine the issuer ID by extracting it from the message received from the contactless card 102 via the client SDK 1292. As mentioned, the issuer ID identifies the issuer of the contactless card 102.

FIG. 12B continues the sequence 1200 from FIG. 12A. In embodiments, the switchboard system 1000 is configured to generate and communicate secure communications with the issuer system, e.g., the client server 1284 and the validator 1288. At 1232, the switchboard system 1000 sends a request for a key to the client server 1284. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1234, the client server 1284 generates a portion of the key. In some instances, the client server 1284 may generate half of the ECDH key for encryption/decryption of PII. Specifically, the client server 1284 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1236, the client-server 1284 stores the generated portion of the key in storage. Specifically, the client server 1284 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1284 may return the public key portion to the switchboard system 1000 with the KEY ID at 1238. The switchboard system 1000 may store the public key portion with the KEY ID for later use, e.g., generation of the ECDH key. At 1240, the switchboard system 1000 may request a validation to be performed by the validator 1288. In one example, the switchboard system 1000 may send a request validation as Request validation <MESSAGE>, <SIGNED SESSION TOKEN>, <CLIENT EC PUBLIC KEY>, <CONSENT DATE>, and the <TOS VERSION>. The validator 1288 may make an out-of-band request back to the switchboard system 1000 for the public key to verify the session at 1242. At 1244, the switchboard system 1000 may provide the node's public key, i.e., <NODE PUBLIC KEY>. Further at 1246, the validator 1288 may utilize the node's public key to verify the secure session token.

In embodiments, the validator 1288 may validate the message at 1248. In embodiments, the validator 1288 may perform a number of validations including ensuring the nonce in the message is correct along with additional information, such as the card's unique identifier (pUID), and the counter value (pATC).

At 1250, the validator 1288 may store information associated with the session. For example, validator 1288 may store the <CONSENT DATE> with the <TOS VERSION> and the <PUID>. The validator 1288 may also generate another portion of the key, e.g., the ECDH key. For example, the 1288 may Generate <ISSUER EC PUBLIC KEY> and <ISSUER EC PRIVATE KEY> using Elliptic Curve P256. The ISSUER EC PUBLIC KEY and ISSUER EC PRIVATE KEY may be the second half of the ECDH key negotiation.

At 1254, the validator 1288 may generate the complete ECDH key. For example, the validator 1288 generates the <ECDH KEY> from <ISSUER EC PRIVATE KEY> and <CLIENT EC PUBLIC KEY>. The ECDH KEY is the final key generated using ECDH key negotiation.

The validator 1288 may utilize the ECDH KEY to encrypt data for the function. For example, if the validator 1288 validates the message in some instances, the validator 1288 may execute a function request to create a function result and encrypt the result with the ECDH KEY at 1256. For example, the validator 1288 may Execute <FUNCTION REQUEST> to create <FUNCTION RESULT> and encrypt it with the <ECDH KEY>. The function result may be any result based on the requested function, e.g., verification of the card.

At 1258, the validator 1288 may return the function result to the switchboard system 1000. In some instances, the function result is returned encrypted. For example, the validator 1288 may return the <ENCRYPTED FUNCTION RESULT> and the <ISSUER EC PUBLIC KEY>.

FIG. 12C continues the sequence 1200 from FIG. 12B. In embodiments, at 1260 the switchboard system 1000 sends the function result to the client server 1284 to process the result. In one example, the switchboard system 1000 may send the <ENCRYPTED FUNCTION RESULT>, <KEY ID>, <ISSUER EC PUBLIC KEY>, and <SIGNED SESSION TOKEN>. At 1262 and 1264, the client server 1284 may make a request for and receive the public key from the switchboard system 1000. In some instances, the exchange may be performed via out-of-band communication channels. The public key for the node may be <NODE PUBLIC KEY>. The public key may be used to verify the sender of the function result, etc. At 1266, the client server 1284 may verify the signed session key with the node's public key <NODE PUBLIC KEY> to verify the sender of the information. At 1268, the client server 1284 may extract client information from the signed session token. For example, the client server 1284 may Extract <CLIENT SESSION INFO> from <SIGNED SESSION TOKEN>, i.e., extracting the client implementation-specific user session identification information.

Further, at 1270, the client server 1284 may retrieve the client's private key with the KEY ID. Specifically, the client server 1284 may get and remove the <CLIENT PRIVATE KEY> from cache using the <KEY ID>. At 1272, the client server 1284 may generate or compute the ECDH key. For example, the client server 1284 may compute the <ECDH KEY> with the <CLIENT PRIVATE KEY>+<ISSUER EC PUBLIC KEY>. The client server 1284 may decrypt the function result with the computed key at 1274. Specifically, the client server 1284 may decrypt the <ENCRYPTED FUNCTION RESULT> with the <ECDH KEY> to determine the <FUNCTION RESULT>. At 1276, the client server 1284 associates the function result with the session.

In embodiments, the switchboard system 1008 may return whether the function result was successfully completed or not at 1278 to the client SDK 1292. Further at 1280, the client SDK 1292 may notify the client app 1290 of the result. At 1282, the client app 1290 may utilize the feature. For example, the 1282 may communicate with the client server 1284 to continue the feature using the <CLIENT SESSION INFO> to fetch the redacted <FUNCTION RESULT>.

FIG. 13 illustrates an example of a message 1300 that may be communicated by a contactless card to perform the functions described herein, such as those discussed in FIG. 12A through FIG. 12C. The message 1300 may include the encrypted data that is sent from the contactless card 102 to the computing device 104 for authentication, as described above. One or more of the fields in message 1300 may also be utilized to route the message 1300 through the switchboard system and perform authentication/validation techniques.

In embodiments, the message 1300 includes an applet version 1302 field, an issuer discretionary indicator 1304 field, an Issuer Identifier 1306 field, a pKey ID 1308 field, a pUID 1310 field, a pATC 1312 field, a nonce 1314 field, and an encrypted cryptogram 1316.

In embodiments, the fields may be in plain text or encrypted. For example, the applet version 1302 field may include an applet version in plain text. The applet version indicates which applet version is installed on a contactless card and may be used by the other systems to determine how to process the message 1300 when communicated. For example, different Applet versions require different validation logic, e.g., an older message may be routed through the issuer system to perform various operations for validation, while a newer message may be routed through the switchboard system to perform the various operations, including validation.

In embodiments, the message 1300 includes an issuer discretionary indicator 1304 field that may include issuer data and set at the time of personalization. In addition, the message 1300 includes an Issuer Identifier 1306 field that may include a unique ID assigned to the entity issuing the card, e.g., the issuer. For example, when joining the system, each issuer may be assigned a unique identifier during an onboarding operation. The issuer ID can be used by the switchboard system 1008 to route a message and its contents to the appropriate services that are associated with that particular issuer.

In embodiments, the message 1300 includes a pKey ID 1308 field. In some instances, the pKey ID 1308 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1300 may include a pUID 1310 field, including a card unique identifier assigned to the contactless card at personalization time. The pUID 1310 field data may be a combination of alphanumeric characters used to identify each card and associated with a user uniquely.

In embodiments, the message 1300 includes a pATC 1312 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1300 is created, a new session key is derived and utilized to generate one or more portions of the message 1300. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1300 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, in response to the contactless card 102 being tapped onto a surface of the device, e.g., brought within wireless communication range, a read operation may be performed on the contactless card 102, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth, WiFi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’∥[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES⁻¹(ASKR) [B], where DES⁻¹ is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

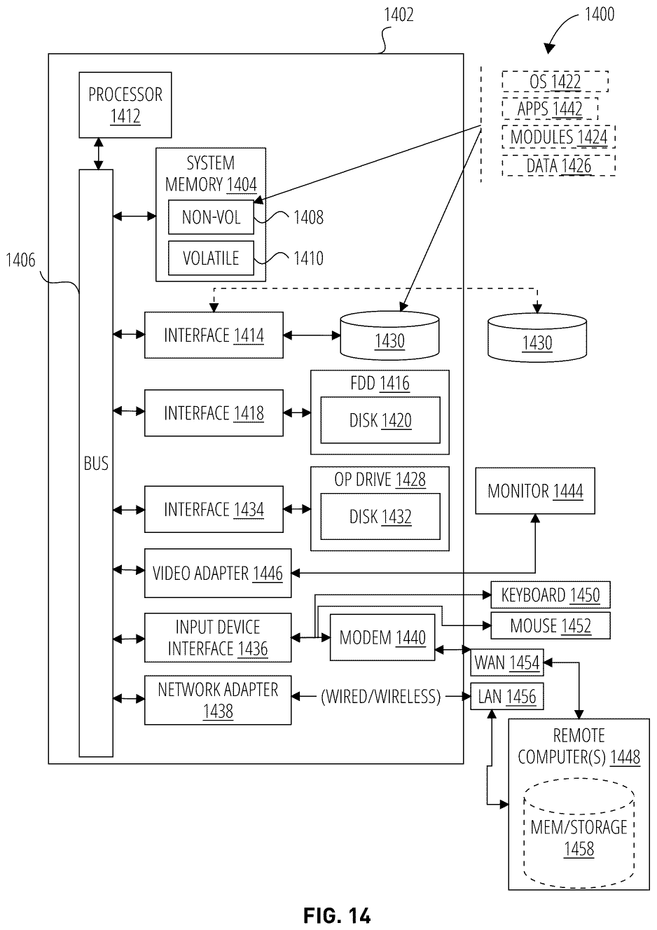

FIG. 14 illustrates an embodiment of an exemplary computer architecture 1400 suitable for implementing various embodiments as previously described. In one embodiment, the computer architecture 1400 may include or be implemented as part of one or more systems or devices discussed herein. For example, the computer architecture 1400 includes components that can implement one or more of the computing device 104, web server 108, bank server 110, authentication server 112, or centralized digital wallet server 114 described above.

As used in this application, the terms “system” and “component” are intended to refer to a computer-related entity, either hardware, a combination of hardware and software, software, or software in execution, examples of which are provided by the exemplary computer architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 1400 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 1500.

As shown in FIG. 14, the computer architecture 1400 includes a processor 1412, a system memory 1404 and a system bus 1406. The processor 1412 can be any of various commercially available processors or processor circuits.

The system bus 1406 provides an interface for system components including, but not limited to, the system memory 1404 to the processor 1412. The system bus 1406 can be any of several types of bus structure that may further interconnect to a memory bus (with or without a memory controller), a peripheral bus, and a local bus using any of a variety of commercially available bus architectures. Interface adapters may connect to the system bus 1406 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1400 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1404 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1404 can include non-volatile 1408 and/or volatile 1410. A basic input/output system (BIOS) can be stored in the non-volatile 1408.

The computer 1402 may include various types of computer-readable storage media in the form of one or more lower speed memory units, including an internal (or external) hard disk drive 1430, a magnetic disk drive 1416 to read from or write to a removable magnetic disk 1420, and an optical disk drive 1428 to read from or write to a removable optical disk 1432 (e.g., a CD-ROM or DVD). The hard disk drive 1430, magnetic disk drive 1416 and optical disk drive 1428 can be connected to system bus 1406 the by an HDD interface 1414, and FDD interface 1318 and an optical disk drive interface 1534, respectively. The HDD interface 1414 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1408, and volatile 1410, including an operating system 1422, one or more applications 1442, other program modules 1424, and program data 1426. In one embodiment, the one or more applications 1442, other program modules 1424, and program data 1426 can include, for example, the various applications and/or components of the systems discussed herein.

A user can enter commands and information into the computer 1402 through one or more wire/wireless input devices, for example, a keyboard 1450 and a pointing device, such as a mouse 1452. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1412 through an input device interface 1436 that is coupled to the system bus 1406 but can be connected by other interfaces such as a parallel port, IEEE 1394 serial port, a game port, a USB port, an IR interface, and so forth.

A monitor 1444 or other type of display device is also connected to the system bus 1406 via an interface, such as a video adapter 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wire and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all the elements described relative to the computer 1402, although, for purposes of brevity, only a memory and/or storage device 1458 is illustrated. The logical connections depicted include wire/wireless connectivity to a local area network 1456 (LAN) and/or larger networks, for example, a wide area network 1454 (WAN). Such LAN and WAN networking environments are commonplace in offices and companies, and facilitate enterprise-wide computer networks, such as intranets, all of which may connect to a global communications network, for example, the Internet.

When used in a local area network 1456 networking environment, the computer 1402 is connected to the local area network 1456 through a wire and/or wireless communication network interface or network adapter 1438. The network adapter 1438 can facilitate wire and/or wireless communications to the local area network 1456, which may also include a wireless access point disposed thereon for communicating with the wireless functionality of the network adapter 1438.

When used in a wide area network 1454 networking environment, the computer 1402 can include a modem 1440, or is connected to a communications server on the wide area network 1454 or has other means for establishing communications over the wide area network 1454, such as by way of the Internet. The modem 1440, which can be internal or external and a wire and/or wireless device, connects to the system bus 1406 via the input device interface 1436. In a networked environment, program modules depicted relative to the computer 1402, or portions thereof, can be stored in the remote memory and/or storage device 1458. It will be appreciated that the network connections shown are exemplary and other means of establishing a communications link between the computers can be used.

The computer 1402 is operable to communicate with wire and wireless devices or entities using the IEEE 1202 family of standards, such as wireless devices operatively disposed in wireless communication (e.g., IEEE 1202.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

The various elements of the devices as previously described with reference to FIGS. 1-14 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, the term “merchant” is not limited to a particular merchant or type of merchant. Rather, the term includes any type of merchant, vendor, or other entity involved in activities where products or services are sold or otherwise provided.

As used herein, the term “bank” is not limited to a financial institution or other type of entity. Rather, the term includes any type of financial institution, business or industrial organization, or other entity involved in the handling or processing of transactions.

As used herein, the term “account” is not limited to a particular type of account. Rather, it is understood that the term “account” can refer to a variety of accounts, including without limitation, a financial account (e.g., a credit account, a debit account, etc.), a membership account, a loyalty account, a subscription account, a services account, a utilities account, a transportation account, and a physical access account. It is further understood that the present disclosure is not limited to accounts issued by a particular entity.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A method, comprising:
providing a browser extension on a web browser of a mobile device, the browser extension enabling operation of a digital wallet on the mobile device, wherein the web browser is configured to access a merchant website including a checkout page having at least one entry field thereon, and wherein providing the browser extension includes automatically installing the browser extension with a computer application being installed on the mobile device;
automatically prompting, by the browser extension, a user to select a payment instrument from a list of one or more payment instruments associated with the digital wallet;
receiving, by the browser extension, a selection of the payment instrument;
launching the computer application, the computer application corresponding to the payment instrument selected;
receiving authentication data of the user at the computer application;
sending the authentication data to an authentication server for validation;
in response to the authentication data of the user being validated, the browser extension receiving, from a centralized digital wallet server, an authorization token, wherein the mobile device is redirected from the computer application back to the merchant website on the web browser;
sending, by the browser extension, a request to the centralized digital wallet server for personal data associated with the user, the request including the authorization token;
receiving, by the browser extension from the centralized digital wallet server, the personal data associated with the user; and
populating, by the browser extension, at least one entry field on the checkout page with the personal data.

2. The method of claim 1, wherein providing the browser extension includes automatically installing the browser extension simultaneously with the computer application being installed on the mobile device; and
wherein the computer application is a mobile banking application or a mobile credit card issuer application.

3. The method of claim 1, wherein the method further includes prompting the user to enter login credentials into the computer application, the login credentials being one factor of authentication data received at the computer application.

4. The method of claim 1, wherein the browser extension receiving the authorization token includes the browser extension receiving a universal resource locator (URL), the URL including the authorization token.

5. The method of claim 1, wherein receiving authentication data of the user includes prompting the user to tap a contactless card listed as one of the one or more payment instruments to the mobile device, the method further comprising:
receiving encrypted data from the contactless card, wherein the authentication data is the encrypted data; and
sending the encrypted data to the authentication server to validate the encrypted data and identity of the user.

6. The method of claim 1, wherein receiving authentication data of the user includes receiving a text message with a one-time passcode; and
the method further comprising:
receiving the one-time passcode in the computer application; and
sending the one-time passcode as the authentication data to the authentication server to verify the one-time passcode.

7. The method of claim 1, wherein the method further includes sending the web browser a temporary browser data file to store within the web browser to permit the browser extension to automatically populate the at least one entry field with the personal data again at a future time.

8. The method of claim 7, wherein the browser data file permits the browser extension to automatically populate the at least one entry field with the personal data at the future time without requiring authentication of the identity of the user until the browser data file expires.

9. The method of claim 7, wherein the browser data file is generated by the centralized digital wallet server or a server in communication with the computer application, the server acting as an application backend pair with the computer application; and
wherein the browser data file is bound to the merchant.

10. The method of claim 1, wherein the personal data associated with the user includes a bound virtual card number (BVCN) associated with the payment instrument or personal identification information (PII) of the user.

11. The method of claim 10, wherein the BVCN is bound to the merchant and cannot be used by the browser extension to populate fields associated with any other merchant or website.

12. A computing device, comprising:
a memory storing executable instructions thereon; and
a processing circuit to execute the instructions, which when executed, cause the processing circuit to:
access a website via a web browser, the website including a webpage having at least one entry field to be filled with data;
enable operation of a digital wallet by activating a browser extension on the web browser, the browser extension being associated with a bank with which a user of the computing device has a banking account;
display a prompt for the user to select a payment method from a list of one or more payment methods saved within the digital wallet;
receive a selection from the user for the payment method;
execute, based on the selection, a mobile banking application, and display within the mobile banking application, a prompt for the user to provide login credentials for the mobile banking application, wherein the browser extension is automatically installed on the web browser with the banking application being installed on the computing device;
receive the login credentials from the user;
in response to the login credentials being validated, receive an authentication token from a digital wallet server, the authentication token being received by the browser extension;
send, from the browser extension, a request to a digital wallet server for personal data associated with the user, the request including the authentication token;
receive, at the browser extension, the personal data from the digital wallet server; and
use the browser extension to automatically fill the at least one entry field with the personal data associated with the user.

13. The computing device of claim 12, wherein the browser extension is automatically installed on the web browser simultaneously with the banking application being installed on the computing device.

14. The computing device of claim 12, wherein the processing circuit is further caused to redirect the computing device back to the web browser in response to receiving the authentication token.

15. The computing device of claim 12, wherein the processing device is further to:
prompt the user to provide authentication data to validate an identity of the user,
send the authentication data to an authentication server for validation; and
receive an indication from the authentication server that the authentication data is validated.

16. The computing device of claim 12, wherein the processing device is further to:
instruct the browser extension to cause a text message to be sent to a mobile device of the user with a one-time passcode;
receive as user input into the browser extension the one-time passcode; and
forward the one-time passcode to an authentication server for validation.

17. The computing device of claim 12, wherein the personal data associated with the user includes a bound virtual card number (BVCN) associated with the contactless card or personal identification information (PII) of the user.

18. The computing device of claim 17, wherein the processing circuit is further caused to receive a temporary browser data file to store within the web browser to permit the browser extension to automatically fill the at least one entry field with the personal data again in the future without requiring authentication of the identity of the user until the browser data file expires.

19. The computing device of claim 18, wherein the browser data file is bound to the website and wherein the BVCN is also bound to the website and cannot be used by the browser extension to populate fields associated with any other website.

20. A non-transitory computer-readable storage medium having executable instructions stored thereon, the computer-readable storage medium including instructions that when executed by a processing circuit of a computing device, cause the computing device to:
execute a browser extension on a web browser of the computing device, the browser extension enabling operation of a digital wallet on the computing device, wherein the web browser is configured to access a merchant website including a checkout section having at least one personal information field to be filled in;
automatically prompt, by the browser extension, a user to select a payment method from a list of one or more payment methods associated with the digital wallet;
receive, by the browser extension, a selection of the payment method;
launch a computer application corresponding to the payment instrument selected, wherein the browser extension is automatically installed on the web browser with the computer application being installed on the computing device;
receive authentication data of the user at the computer application;
send the authentication data to an authentication server for validation;
receive, from a digital wallet server, an authorization token, wherein the mobile device is redirected from the computer application back to the merchant website on the web browser;
send, by the browser extension, a request to the digital wallet server for personal data associated with the user, the request including the authorization token;
receive, by the browser extension from the digital wallet server, the personal data associated with the user; and
fill, by the browser extension, the at least one personal information field on the checkout section with the personal data.
